(19) United States
(12) Patent Application Publication
(10) Pub. No.: US 2020/0107539 A1
(43) Pub. Date: Apr. 9, 2020

(54) MICROWAVE APPLICATION METHOD AND APPRATUS

(71) Applicants: THE UNIVERSITY OF MELBOURNE, University Of Melbourne, Victoria (AU); GRAINS RESEARCH & DEVELOPMENT CORPORATION, Barton, Australian Capital Territory (AU)

(72) Inventors: Graham Brodie, University Of Melbourne, Victoria (AU); Grigori Trogovnikov, University Of Melbourne, Victoria (AU); Peter Farrell, University Of Melbourne, Victoria (AU)

(21) Appl. No.: 16/470,523

(22) PCT Filed: Dec. 20, 2017
(86) PCT No.: PCT/AU2017/051424

§ 371 Date: Jun. 17, 2019

(30) Foreign Application Priority Data
Dec. 20, 2016 (AU) 2016905272

(51) Int. Cl. A01M 21/04; H05B 6/80; H01P 5/08; H01P 3/16

(52) U.S. Cl. CPC A01M 21/046; H05B 6/80; H05B 2206/045; H01P 3/16; H01P 5/087

(57) ABSTRACT

A microwave energy application apparatus for irradiating a material, comprising: at least one microwave energy source configured to generate microwave energy; at least one microwave applicator having a microwave energy emitting face comprising a dielectric resonator or a slow-wave microwave applicator for directing microwave energy towards the material to be irradiated; and a waveguide coupling microwave energy from the microwave energy source to the microwave applicator for application to a material to be treated.

### TECHNICAL FIELD

The present invention relates to a microwave application method and apparatus for use, for example, as a weed killer for cropping systems.

### BACKGROUND

In an existing approach, a horn antenna is used to direct microwave energy to kill weeds. U.S. Pat. No. 6,401,637, for example, discloses an apparatus for treating soil and subsurface of soil by irradiation with microwave energy to kill weeds. The apparatus is attached to a truck and drawn over the soil to be treated.

U.S. Pat. No. 7,560,673, on the other hand, discloses a conveyor-type apparatus that extracts a layer of soil off the ground and onto the conveyor which is passed through a microwave energy application area.

US Patent Application No. 2012/0091123A1 discloses a microwave system that uses four horn waveguides to direct microwave energy to soil. The microwave system may be mounted on a vehicle.

Brodie G., et al., Microwave Technologies as Part of an Integrated Weed Management Strategy: A Review, International Journal of Agronomy, Volume 2012 describes investigations into the effects of microwaves applied to weeds, such as by horn antennae.

### SUMMARY OF THE INVENTION

According to a first broad aspect, the present invention provides a microwave energy application apparatus for irradiating a material, comprising: at least one microwave energy source configured to generate microwave energy; at least one microwave applicator having a microwave energy emitting face comprising a dielectric resonator for directing microwave energy towards the material to be irradiated; and a waveguide coupling microwave energy from the microwave energy source to the microwave applicator for application to a material to be treated.

The dielectric resonator may comprise, for example, a ceramic, glass, Teflon, or other low loss dielectric material.

According to a second broad aspect, the present invention provides a microwave energy application apparatus for irradiating a material, comprising: at least one microwave energy source configured to generate microwave energy; at least one microwave applicator having a microwave energy emitting face comprising a slow-wave microwave applicator having grooves arranged in parallel across a direction of propagation of the microwave energy; and a waveguide coupling microwave energy from the microwave energy source to the microwave applicator for application to a material to be treated.

The grooves may have a depth of between 6 and 26 mm. In a preferred embodiment, the grooves have a depth of between 6 and 13 mm. In another preferred embodiment, the grooves have a depth between 13 and 26 mm.

In one embodiment, the grooves are perpendicular to the direction of propagation of the microwave energy. In an embodiment, the grooves are mutually spaced substantially equidistantly.

According to a third broad aspect, the present invention provides a microwave energy application apparatus for irradiating a material, comprising: at least one microwave energy source configured to generate microwave energy; at least one microwave applicator having a microwave energy emitting face for emitting microwave energy; and a waveguide coupling microwave energy from the microwave energy source to the microwave applicator for application to a material to be treated, wherein the microwave energy is emitted from the microwave applicator in a direction substantially perpendicular to the direction at which the microwave energy enters the microwave applicator from the waveguide.

In an embodiment, the microwave energy source is configured to output microwave energy with a frequency of approximately 2.45 GHz.

In another embodiment, the microwave energy source is configured to output microwave energy with frequencies between approximately 860 or 960 MHz.

In another embodiment, the microwave energy source is configured to output microwave energy with a frequency of approximately 5.8 GHz.

Optionally, the microwave energy emitting face is planar.

In an embodiment, the microwave energy application apparatus further comprises a reflector located to reflect microwave energy emitted from the microwave energy emitting face, such that the material moves between the reflector and the microwave energy emitting face.

According to a fourth broad aspect, the present invention provides weed, parasite, bacteria, spore, fungi or seed killing device, comprising one or more microwave energy application apparatuses of the first aspect.

According to a fifth broad aspect, the present invention provides soil sterilizing, conditioning or nitrification device, comprising one or more microwave energy application apparatuses of the first aspect.

According to a sixth broad aspect, the present invention provides drying device, comprising one or more microwave energy application apparatuses of the first aspect.

According to a seventh broad aspect, the present invention provides a microwave energy application method, comprising:
providing microwave energy with at least one microwave energy source;
receiving the microwave energy from the microwave energy source with at least one microwave applicator; and
applying the microwave energy with the microwave applicator to a material to be treated;
wherein the microwave applicator comprises one of: a dielectric resonator; and a slow-wave microwave applicator having grooves arranged in parallel across a direction of propagation of the microwave energy.

According to an eighth broad aspect, the present invention provides A microwave energy application method, comprising: providing microwave energy with at least one microwave energy source; receiving the microwave energy from the microwave energy source with at least one microwave applicator; and applying the microwave energy with the microwave applicator to a material to be treated; wherein the microwave energy is emitted from the microwave applicator in a direction substantially perpendicular to the direction at which the microwave energy enters the microwave applicator from the waveguide.

The material to be treated may comprise, for example, weeds, parasites, bacteria, spores, seeds, fungi, or soil.

It should be noted that any of the various individual features of each of the above aspects of the invention, and any of the various individual features of the embodiments described herein including in the claims, can be combined as suitable and desired.

### BRIEF DESCRIPTION OF THE DRAWINGS

In order that the invention can be more clearly ascertained, embodiments will now be described, by way of example, with reference to the accompanying drawings, in which:

FIG. 1 is a schematic diagram of a microwave energy application apparatus according to an embodiment of the present invention;

FIG. 2A is a top orthographic view of the microwave waveguide and slow-wave microwave applicator of the microwave energy application apparatus of FIG. 1 according to an embodiment of the present invention;

FIG. 2B is a bottom orthographic view of the microwave waveguide and slow-wave microwave applicator of the microwave energy application apparatus of FIG. 1 according to another embodiment of the present invention;

FIGS. 2C and 2D are a top orthographic view and an elevation, respectively, of the microwave waveguide and slow-wave microwave applicator of a microwave energy application apparatus;

FIGS. 3A to 3F are views of multiple examples of the microwave energy application apparatus of FIG. 1 deployed in a trailer pulled by a tractor, FIGS. 3A to 3C being side, top orthographic and plan views of the overall assembly, FIGS. 3D to 3F being rear, top orthographic and side views of the trailer;

FIG. 3G is a view of certain components of a variant of the trailer of FIGS. 3A to 3F;

FIG. 4 is a schematic cross-sectional view of the comb-like slow-wave structure of the slow-wave microwave applicator of the microwave energy application apparatus of FIG. 1 according to an embodiment of the present invention, with the intensity of the energy associated with the slow-wave structure;

FIG. 5 is a schematic circuit diagram of a distributed impedance in a transmission line, illustrating operation of the slow-wave microwave applicator of this embodiment;

FIG. 6 is a schematic circuit diagram of an inductive element, illustrating operation of the slow-wave microwave applicator of this embodiment;

FIG. 7 is a schematic circuit diagram of a shunt capacitance, illustrating operation of the slow-wave microwave applicator of this embodiment;

FIG. 8 is a schematic circuit diagram of an equivalent LC network, illustrating operation of the slow-wave microwave applicator of this embodiment;

FIG. 9 is a schematic cross-sectional view of the comb-like slow-wave structure of the slow-wave microwave applicator of the microwave energy applicator of FIG. 1 according to an embodiment of the present invention with a dielectric plate and adjacent soil;

FIGS. 10A and 10B are plots of temperature distributions of a horn antenna of the background art and of a slow-wave applicator according to this embodiment, respectively, when fed with 55.5 kJ of microwave energy at 2.45 GHz frequency;

FIG. 11 is a schematic view of the microwave waveguide and slow-wave microwave applicator of the embodiment of FIG. 1, with a groove depth of d=6 mm;

FIG. 12 is a schematic view of a slow-wave microwave applicator with microwave waveguide of an alternative embodiment, with a groove depth of d=13 mm;

FIG. 13 is an elevation of a slow-wave microwave applicator according to an embodiment of the present invention, with slow-wave structure omitted;

FIGS. 14 to 16 are bottom, top orthographic and bottom orthographic views, respectively, of the slow-wave microwave applicator of FIG. 13, with slow-wave structure omitted;

FIG. 17 is a bottom orthographic view of the applicator housing of the slow-wave microwave applicator of FIG. 13;

FIGS. 18A to 18C are top, cross-sectional and bottom views, respectively, of a transitional portion of the slow-wave microwave applicator of FIG. 13;

FIG. 19A is a schematic elevation of the slow-wave structure of the slow-wave microwave applicator of FIG. 13 (with groove depth d=6 mm);

FIG. 19B is a schematic elevation of the slow-wave structure of the slow-wave microwave applicator of FIG. 13 (with groove depth d=13 mm);

FIG. 20A is a bottom orthographic view of slow-wave structure of the slow-wave microwave applicator of FIG. 13 (with groove depth d=6 mm);

FIG. 20B is a bottom orthographic view of the slow-wave structure of the slow-wave microwave applicator of FIG. 13 (with groove depth d=13 mm);

FIGS. 21A and 21B are a bottom orthographic view and an elevation, respectively, of the bend section of the waveguide of the microwave energy application apparatus of FIG. 1;

FIGS. 22A and 22B are an orthographic view and a schematic plan view, respectively, of the transition section of the waveguide of the microwave energy application apparatus of FIG. 1;

FIG. 23 is a schematic diagram of a microwave energy application apparatus according to another embodiment of the present invention;

FIGS. 24A to 24C are elevation, plan and isometric views respectfully of the ceramic block of the microwave energy application apparatus of FIG. 23;

FIG. 25 is a schematic analysis of electromagnetic waves at a medium interface for parallel polarisation relative to the plane of incidence;

FIG. 26 is a view of the microwave field distribution in the ceramic block of FIG. 23 for the combination of TE308 and TE106 modes;

FIG. 27 is a thermal image of plywood when heated using the microwave applicator of FIG. 23;

FIG. 28 is a thermal contour map of the thermal image of FIG. 27;

FIG. 29 is a thermal image of soil when heated using the microwave applicator of FIG. 23;

FIG. 30 is a thermal contour map of the thermal image of FIG. 29;

FIG. 31 is a thermal image of the ground when heated using the microwave applicator of FIG. 23;

FIG. 32 is a thermal contour map of the thermal image of FIG. 31;

FIG. 33 is a thermal image of the ceramic block of the microwave applicator of FIG. 23 after about 40 minutes of use;

FIG. 34 is a thermal contour map of the thermal image of FIG. 33; and

FIG. 35 shows the microwave energy application apparatus including a reflector.

### DETAILED DESCRIPTION

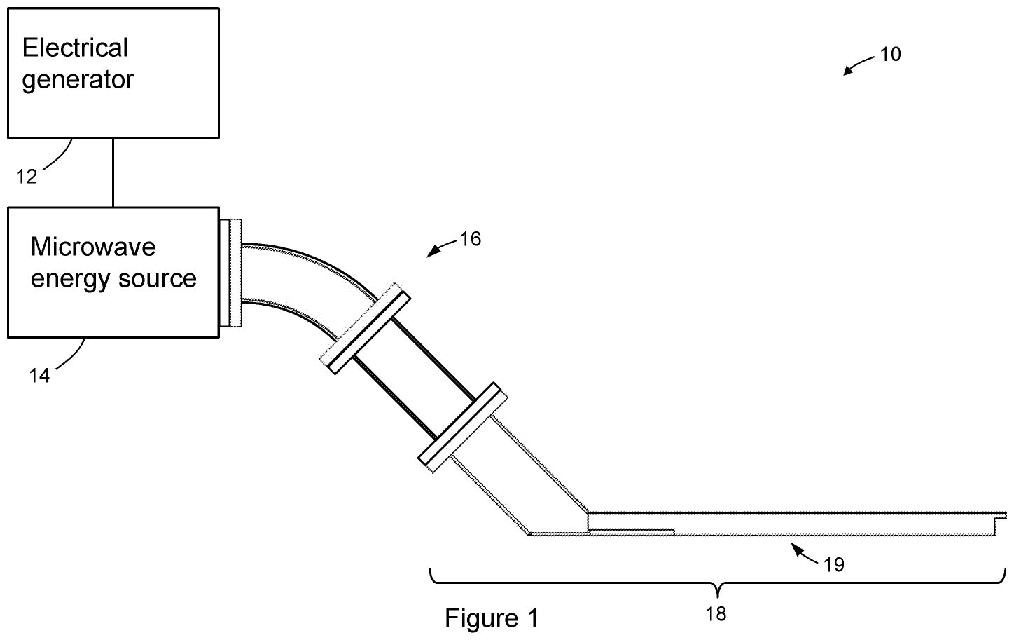

According to an embodiment of the present invention, there is provided a microwave energy application apparatus, shown schematically at 10 in FIG. 1. The intended principal application of microwave energy application apparatus 10 is as a weed killer for cropping systems, operating by heating and thereby killing or destroying the viability of weeds and/or weed seeds. It should be appreciated that it may also or alternatively be used, for example, to condition soil, to promote nitrification, and/or to reduce the bacterial burden of soil. In some tests, for example, it has been found possible to reduce total soil bacterial burden by approximately 90%. Microwave energy application apparatus 10, or alternative embodiments thereof, may also find application in horticulture, in place of fumigation (such as in glasshouses, or of cargo or soil for sale), to kill parasites, and to increase the availability of nutrients in soil.

Microwave energy application apparatus 10 is adapted to be mounted to a wheeled platform pulled by a vehicle, such as a tractor or other farm vehicle, and—in this embodiment—accordingly ultimately derives power from that vehicle. This may be, for example, by operative engagement with an axle, wheel or Power Take Off (PTO) of the vehicle. Referring to FIG. 1, therefore, microwave energy applicator 10 includes an electrical generator 12 (shown in highly schematic form) that can engage and be driven by an axle, wheel or PTO of the vehicle, a microwave energy source or sources 14 (also shown in highly schematic form) powered by the electrical output of the electrical generator 12, a microwave waveguide 16 and a microwave applicator in the form of a slow-wave microwave applicator 18 with a downwardly directed microwave energy emitting face 19.

Microwave energy source 14 generates microwave energy at, in this embodiment, 2.45 GHz, and microwave waveguide 16 and slow-wave microwave applicator 18 are sized accordingly. In other embodiments, however, microwave energy source or sources may be employed that generate microwave energy at other wavelengths, such as 860 MHz to 960 MHz, or 5.8 GHz. The choice of frequency may depend, for example, on convenience: commercially available microwave energy sources are commonly adapted to output microwave energy of the aforementioned frequencies, so these may be readily and economically available, but other criteria may be contemplated according to intended application. For example, the composition and/or moisture of soil to which microwaves are applied may influence the choice of operating frequency.

Waveguide 16 is arranged to guide the microwave energy output of the microwave energy source 14 to the microwave applicator 18, and the microwave applicator 18 is arranged to direct that output as desired, in this example downwardly—in use mounted to the vehicle—towards the ground.

Slow-wave microwave applicator 18, in this embodiment, is adapted for use as a weed killer for cropping systems. It comprises a slow-wave structure, which comprises non-radiating open transmission lines that confine the electromagnetic field distribution so that the electromagnetic field remains very close to the surface of the slow-wave structure, and decays exponentially with distance from the surface of the slow-wave structure, thereby increasing the efficacy or efficiency of the treatment of soil or plants.

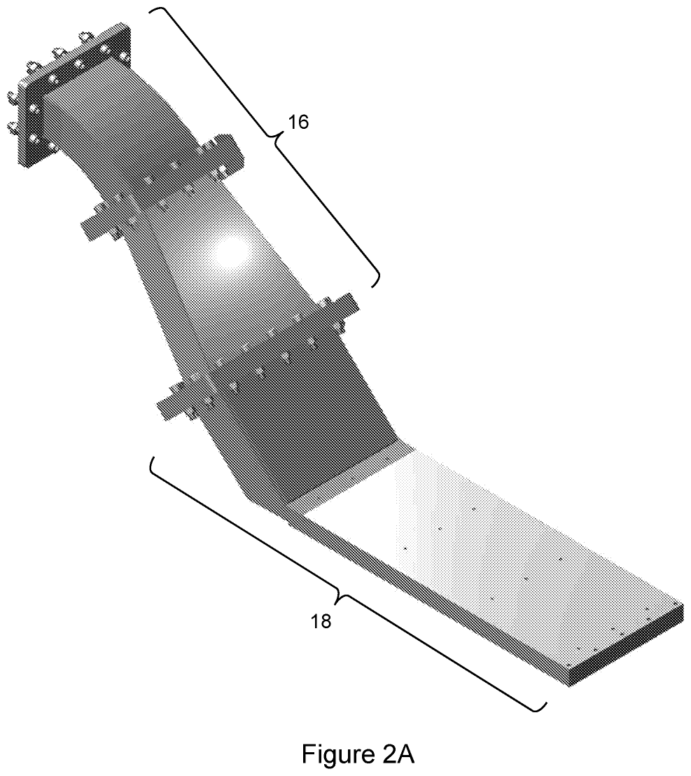

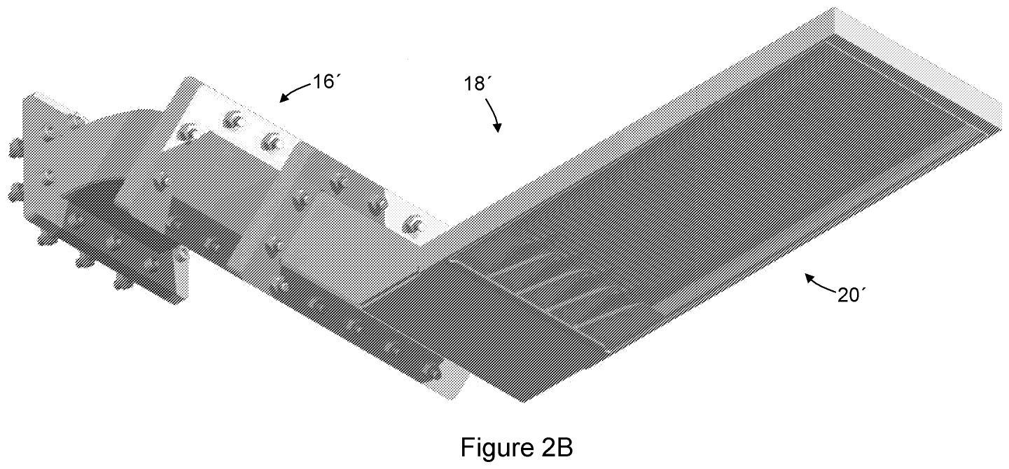

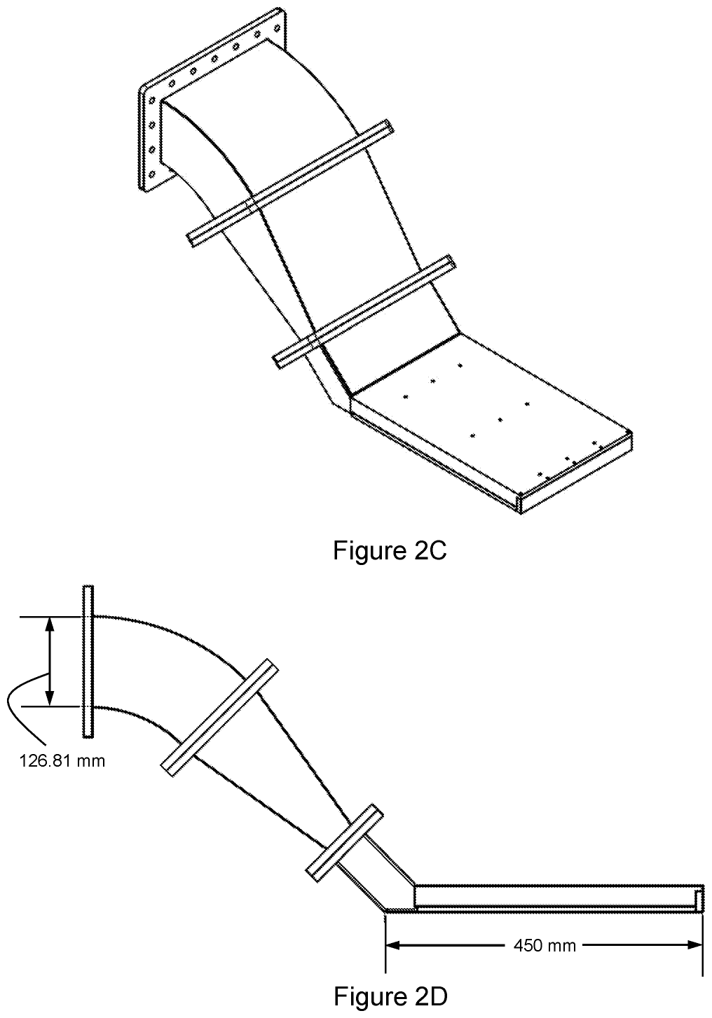

FIG. 2A is an orthographic view of waveguide 16 and microwave applicator 18, while FIG. 2B is another orthographic view—generally from underneath—of the microwave waveguide 16′ and slow-wave microwave applicator 18′ of a microwave energy application apparatus according to another embodiment of the present invention, adapted for use with 2.45 GHz microwaves. In FIG. 2B, the slow-wave structure 20′ (including parallel grooves that are equidistantly spaced and—in this embodiment—perpendicular to the direction of propagation of the microwave energy) is depicted. It will be noted that the precise length of the grooves will differ depending on the frequency of microwaves used.

As shown, the slow-wave microwave applicator 18 emits microwave energy from a substantially planar face. As can be seen, the waveguide 16 directs microwave energy into the slow-wave microwave applicator 18 at an angle substantially perpendicular to the direction at which microwave energy is emitted from the slow-wave microwave applicator 18.

Additionally, it is envisaged that the grooves need not be perpendicular to the direction of propagation of the microwave energy. A departure from perpendicular may lead to perturbations in the microwave field, but it is expected that useful embodiments may still be possible, especially with small departures of the grooves from being perpendicular to the direction of propagation of the microwave energy. An acceptable degree of departure from perpendicular will be readily ascertained by simple trial and error—in particular through measurement of the microwave energy emitted by slow-wave structure 20,20′.

FIGS. 2C and 2D are a top orthographic view and an elevation, respectively, of the microwave waveguide 16′ and slow-wave microwave applicator 18′ of the embodiment of FIG. 2B according to another embodiment of the present invention, adapted for use with 860 MHz to 960 MHz microwaves.

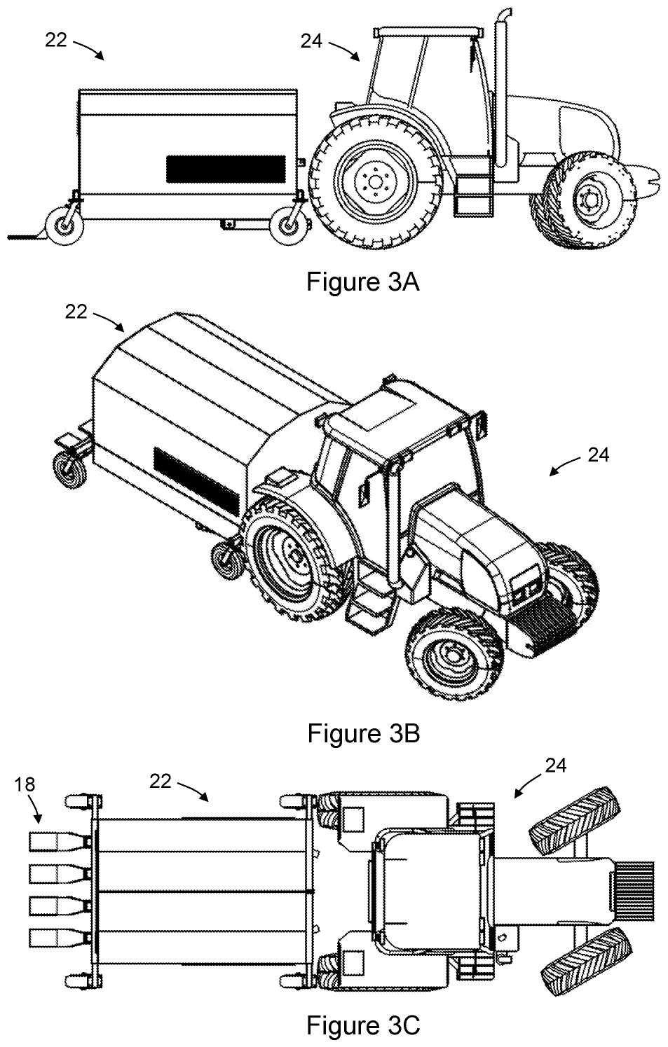

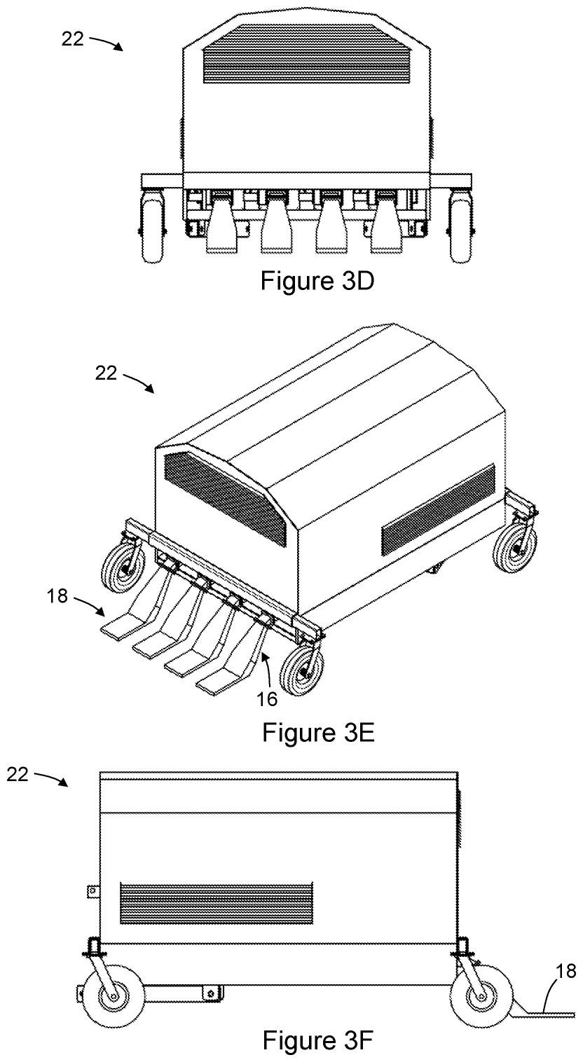

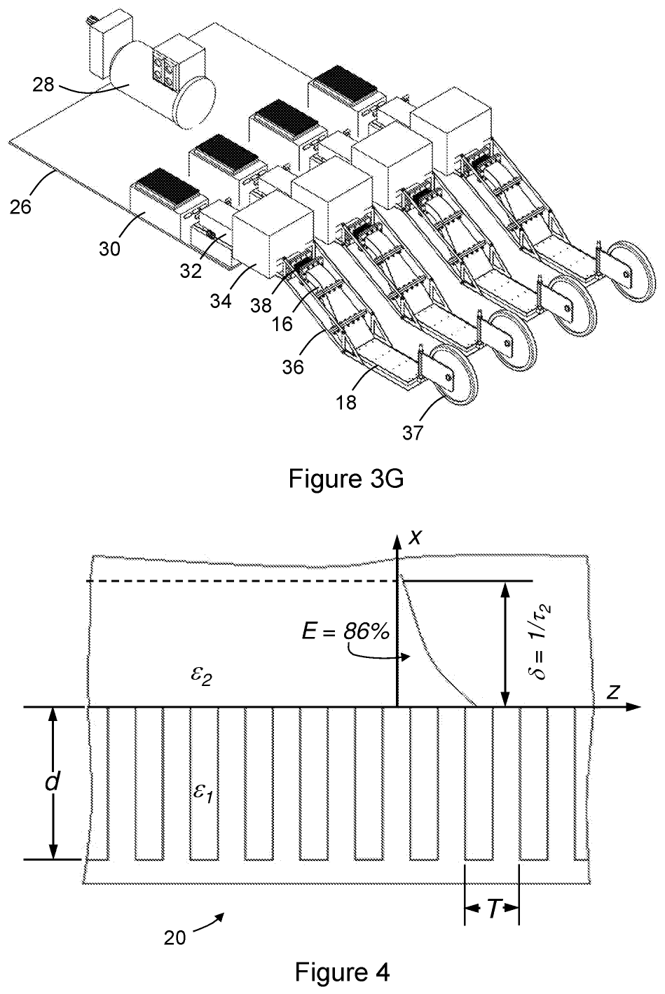

FIGS. 3A to 3F are views of multiple examples of microwave energy application apparatus 10 deployed in a trailer 22 pulled by a tractor 24. FIGS. 3A to 3C are side, top orthographic and plan views of the overall assembly, while FIGS. 3D to 3F are rear, top orthographic and side views of trailer 22.

FIG. 3G is a view of certain components of a variant of trailer 22. Referring to FIG. 3G, in this variant (as in trailer 22), the trailer includes a trailer deck 26, and a PTO electrical generator 28 (coupled to the PTO (not shown) of tractor 24). FIG. 3G also depicts respective switched mode microwave power supplies 30, microwave magnetron heads 32 and autotuners 34 of the respective apparatuses 10. Unlike trailer 22 of FIGS. 3A to 3F, however, this variant trailer also includes respective supporting trusses 36 and dolly wheels 37 for supporting the respective microwave waveguides 16 and slow-wave microwave applicators 18. In this variant, apparatuses 10 each include a short section of flexible waveguide 38 between microwave waveguide 16 and autotuner 34, and supporting trusses 36 are pivotably mounted to trailer deck 26 so that—owing to dolly wheels 37—the respective slow-wave microwave applicators 18 are supported mutually independently at a substantially constant height above the ground.

The basic form of the comb-like slow-wave structure 20 is shown schematically in cross-sectional view in the lower register of FIG. 4; the intensity of the energy outputted by the slow-wave structure 20 in shown in the upper register of the figure.

The effect of slow-wave structure 20 may be analyzed as follows. Firstly,

$${λ}_{0} = \frac{f}{c} ,$$

where λ₀ is the wavelength in free space (m), f is the frequency (Hz), and c is the speed of light in free space (ms⁻¹),

ω=2πf,

where ω is the angular velocity (rad s⁻¹),

$$k = \frac{ω}{c}$$

$$and$$

$$θ = \frac{g}{T} ,$$

where g is the gap width of the structure (m) and T is the period of the structure (m).

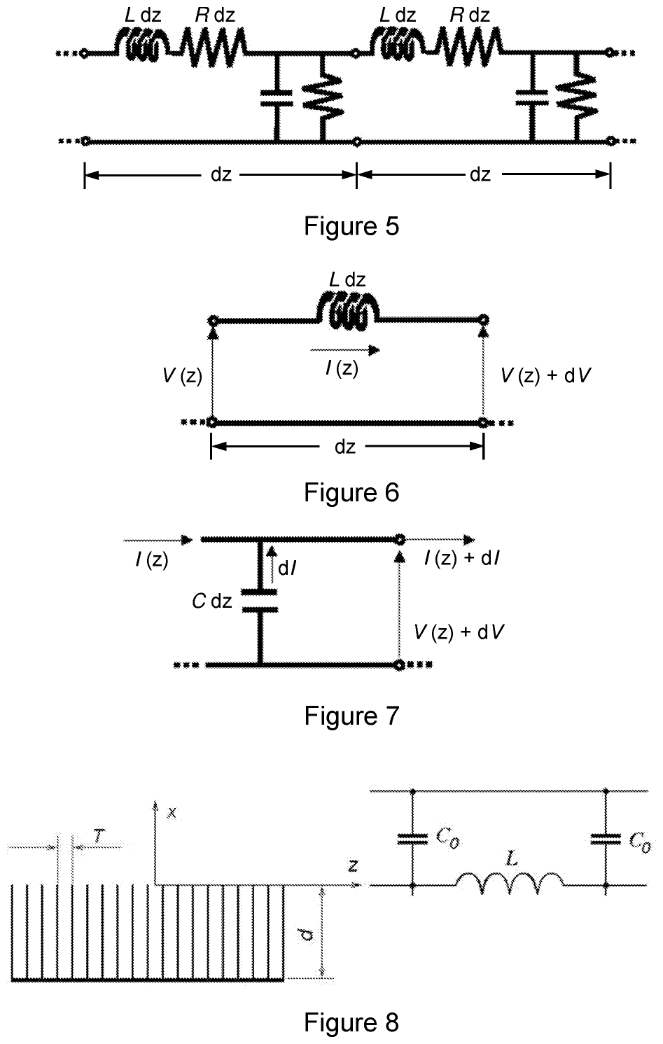

A uniform transmission line may be depicted as a “distributed circuit”, as shown schematically in FIG. 5. A distributed circuit can be described as a cascade of identical cells of infinitesimal length dz. The conductors used in a transmission line possess a certain series inductance and resistance. In addition, there is a shunt capacitance between the conductors and even a shunt conductance if the medium insulating the wires is not a perfect insulator. In many cases, it is possible to neglect the resistive effects in the transmission line, as shown schematically in FIG. 6.

From this analysis it may be seen that:

V(z)+dV(z)−V(z)=−jωL·dz·I(z)

Therefore:

$$\frac{dV ( z )}{dz} = - j ω L \cdot I ( z ) \qquad ( A1 )$$

One should then consider the shunt element, as shown schematically in FIG. 7. The current flowing in the capacitor of this element is:

dI(z)=−jωC·dz·[V(z)+dV]=−jωC·dz·V(z)−jωC·dz·dV

The limit lim_{dz→0} dz·dV=0, so

$$\frac{dI ( z )}{dz} = - j ω C \cdot V ( z ) \qquad ( A2 )$$

Taking the derivative of equation (A1) with respect to z and substituting from equation (A2) yields:

$$\frac{{d}^{2} V ( z )}{{dz}^{2}} = - j ω L \cdot \frac{dI ( z )}{dz} = - {ω}^{2} \cdot LC \cdot V ( z ) .$$

This is a wave equation, the solution of which is:

$$V ( z ) = {V}_{1} {e}^{- j ω \sqrt{LC} \cdot z} + {V}_{2} {e}^{j ω \sqrt{LC} \cdot z} .$$

In this case the general solution represents a wave propagating in both the +z and −z direction with a wave number of τ=ω\sqrt{LC} and a velocity

$${c}^{′} = \frac{1}{\sqrt{LC}} .$$

A slow-wave structure behaves like a transmission line so can be regarded as a distributed LC network (cf. FIG. 8, depicting an equivalent LC circuit). The gaps between the teeth of the slow-wave structure 20 can be regarded as shorted transmission lines. A short circuited transmission line is inductive when its phase constant (kd) is less than 90°, open circuited when the phase constant equals 90°, and capacitive when the phase constant is greater than 90°. In the case of slow-wave structure 20, the short length of the groove keeps the input impedance at the open ends of the comb inductive.

The input impedance of a loaded transmission line of length d and unit width (dy) is given by:

$${Z}_{i n} \cdot dy = {Z}_{o} [ \frac{{e}^{j k d} + Γ {e}^{- j kd}}{{e}^{jkd} - Γ {e}^{- jkd}} ]$$

In this case,

$$Γ = \frac{{Z}_{L} - {Z}_{o}}{{Z}_{L} + {Z}_{o}}$$

therefore:

$${Z}_{i n} \cdot dy = {Z}_{o} [ \frac{{e}^{jkd} + \frac{{Z}_{L} - {Z}_{o}}{{Z}_{L} + {Z}_{o}} {e}^{- jkd}}{{e}^{jkd} - \frac{{Z}_{L} - {Z}_{o}}{{Z}_{L} + {Z}_{o}} {e}^{- jkd}} ]$$

This can be manipulated to become:

$${Z}_{i n} \cdot dy = {Z}_{o} [ \frac{( {Z}_{L} + {Z}_{o} ) {e}^{jkd} + ( {Z}_{L} - {Z}_{o} ) {e}^{- jkd}}{( {Z}_{L} + {Z}_{o} ) {e}^{jkd} - ( {Z}_{L} - {z}_{o} ) {e}^{- jkd}} ]$$

$$or$$

$${Z}_{i n} \cdot dy = {Z}_{o} [ \frac{{Z}_{L} ( {e}^{jkd} + {e}^{- jkd} ) + {Z}_{o} ( {e}^{jkd} - {e}^{- jkd} )}{{Z}_{L} ( {e}^{jkd} - {e}^{- jkd} ) + {Z}_{o} ( {e}^{jkd} + {e}^{- jkd} )} ] .$$

Now (e^{jkd}+e^{-jkd})=2 Cos(kd) and (e^{jkd}−e^{-jkd})=2j Sin(kd), so:

$${Z}_{i n} \cdot dy = {Z}_{o} [ \frac{2 {Z}_{L} Cos ( kd ) + 2 {Z}_{o} j Sin ( kd )}{2 {Z}_{L} j Sin ( kd ) + 2 {Z}_{o} Cos ( kd )} ] = {Z}_{o} [ \frac{{Z}_{L} Cos ( kd ) + {Z}_{o} j Sin ( kd )}{{Z}_{L} j Sin ( kd ) + {Z}_{o} Cos ( kd )} ]$$

In the case of a shorted transmission line, Z_{L}=0, therefore:

$${Z}_{i n} \cdot dy = {Z}_{o} [ \frac{0 + {Z}_{o} j Sin ( kd )}{0 + {Z}_{o} Cos ( kd )} ] = j {Z}_{o} Tan ( kd )$$

The equivalent inductance for this input impedance is:

X_{L}=jωL=jZₒ Tan(kd)

Therefore,

$$L \cdot dy = \frac{{Z}_{o}}{ω} Tan ( kd ) = \frac{\sqrt{\frac{{μ}_{o}}{{ɛ}_{o}}} \sqrt{{μ}_{o} {ɛ}_{o}}}{ω \sqrt{{μ}_{o} {ɛ}_{o}}} Tan ( kd ) = \frac{{μ}_{o}}{k} Tan ( kd ) .$$

The total inductance across the width of the short circuited transmission line (i.e. the groove in the slow-wave structure) is:

$$L {\int }_{0}^{W} \cdot dy = \frac{{μ}_{o}}{k} Tan ( kd )$$

$$or$$

$$L \cdot W = \frac{{μ}_{o}}{k} Tan ( kd ) .$$

Hence,

$$L = \frac{{μ}_{o}}{kW} Tan ( kd ) ,$$

where W is the width of the structure in the y direction (m).

Capacitance is defined as:

$$C = \frac{{ɛ}_{0} {κ}^{′} A}{d} ,$$

where A is the surface area of a conductive plate and d is the distance between plates in a conventional capacitor. In the case where an electric field exists over a conductive surface, the capacitance per unit length of the surface is:

$$C = \frac{{ɛ}_{0} κ′W}{δ} ,$$

where δ is the field penetration depth of the field in the space above the plate and W is the width of the plate. In the specific case of the slow-wave structure the penetration depth of the field in the x direction is:

$$δ = \frac{1}{τ} ;$$

hence, the capacitance per unit length of the structure is:

Cₒ=ε₀κ′Wτ.

Substituting the inductance and capacitance into τ=ω\sqrt{LC} yields:

$${τ}^{2} = {ω}^{2} \frac{{μ}_{o}}{k W} tan ( kd ) {ɛ}_{0} {κ}^{′} W τ$$

This simplifies to:

τ=kκ′ tan(kd). (A3)

The phase velocity of the slow-wave can be determined as:

β²=k²κ′+τ². (A4)

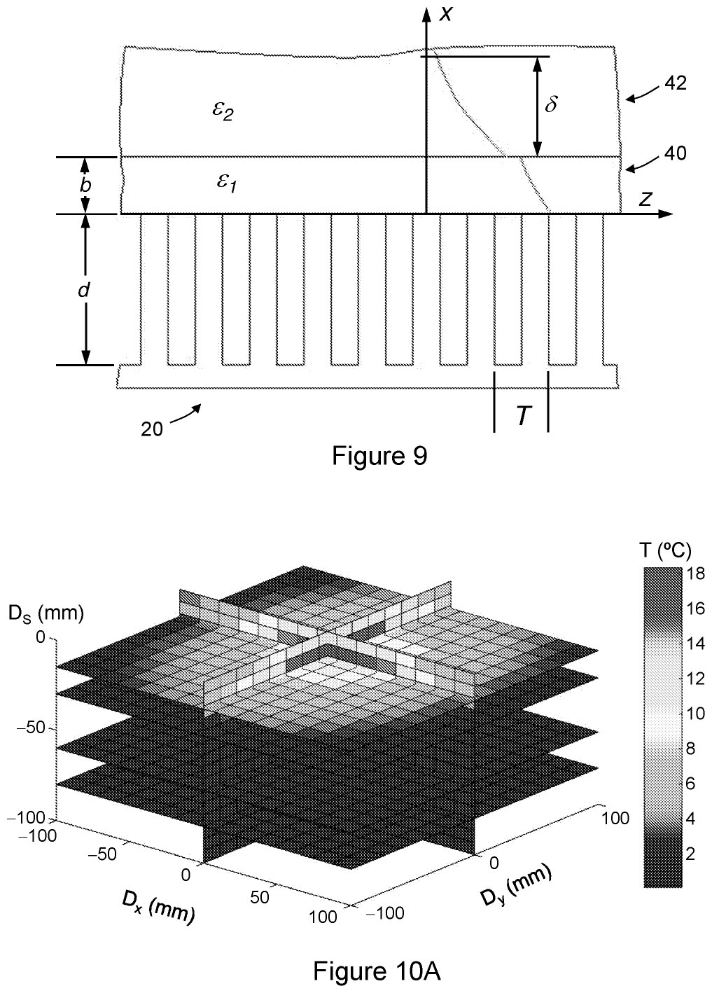

There may be two different media adjacent to the slow-wave structure 20, as depicted schematically in FIG. 9. Referring to FIG. 9, in this example, adjacent to the slow-wave structure 20 is a dielectric plate 40, adjacent to which is soil 42.

In that case, the phase velocity at the boundary of the two media (40, 42) is the same in order to maintain wave continuity across the boundary. The phase velocity in the first medium (e.g. dielectric plate 40) is:

β²=k²κ′₁+τ₁² (A5)

and the phase velocity in the second medium (e.g. soil 42) is:

β²=k²κ′₂+τ₂² (A6)

Subtracting equation (A5) from equation (A6) yields:

0=k²κ′₂+τ₂²−k²κ′₁−τ₁².

Rearranging gives:

τ₂²=τ₁²+k²(κ′₁−κ′₂)

or

τ₂=\sqrt{τ₁²+k²(κ′₁−κ′₂)}. (A7)

The slowing factor for the structure can be determined using Verbitskii (1980):

$$a = \frac{τ d}{2 π} , and$$

$$b = \frac{β d}{2 π} .$$

Then the slowing factor is defined as:

$$N = \frac{1}{b} - ϕ ( b ) f ( θ ) + \frac{2 ( b - a ) P}{b [ ( a - b ) P + a + b ]} \\ where P = {[ {( 1 - θ )}^{1 - θ} {( 1 + θ )}^{1 + θ} ]}^{- 2 b} \\ f ( θ ) = 2 ln ( 4 θ ) + \frac{1 - θ}{θ} ln ( 1 - θ ) - \frac{1 + θ}{θ} ln ( 1 + θ ) \\ ϕ ( b ) = ψ ( 1 + b ) + ψ ( 1 - b ) + 2 γ \\ γ = {Euler}^{′} s constant = 0.5772 … \\ ψ ( z ) = \frac{{Γ}^{′} ( z )}{Γ ( z )} is the digamma function \qquad ( A8 )$$

The longitudinal electric field is defined as:

E_{z}=Eₒe^{j(ωt-βz)}·e^{-τx}\hat{k} (A9)

Note: there is no variation of the E field in the y direction, that is, across the slow-wave structure.

Using

$$∇ \cdot E = \frac{ρ}{ɛ} = 0 ;$$

assuming no free charges in the field:

$$( A 10 )$$

$$\frac{\partial {E}_{x}}{\partial x} + \frac{\partial {E}_{y}}{\partial y} + \frac{\partial {E}_{z}}{\partial z} = 0 \\ ∴ \frac{\partial {E}_{x}}{\partial x} = - \frac{\partial {E}_{z}}{\partial z} = - \frac{\partial }{\partial z} {E}_{o} {e}^{j ( ω t - β z )} \cdot {e}^{- τ x}$$

$$\frac{\partial {E}_{x}}{\partial x} = j β {E}_{o} {e}^{j ( ω t - β z )} \cdot {e}^{- τ x} \\ ∴ {E}_{x} = j β {E}_{o} {e}^{j ( ω t - β z )} \cdot \int {e}^{- τ x} \cdot dx$$

$${E}_{x} = - j \frac{β}{τ} {E}_{o} {e}^{j ( ω t - β z )} \cdot {e}^{- τ x}$$

$$Using ∇ \times H = ɛ \frac{\partial E}{\partial t}$$

$$( \frac{\partial {H}_{z}}{\partial y} - \frac{\partial {H}_{y}}{\partial z} ) \hat{i} + ( \frac{\partial {H}_{x}}{\partial z} - \frac{\partial {H}_{z}}{\partial x} ) \hat{j} + ( \frac{\partial {H}_{y}}{\partial x} - \frac{\partial {H}_{x}}{\partial y} ) \hat{k} = ɛ \frac{\partial E}{\partial t}$$

Resolving for separate coordinate directions:

$$( \frac{\partial {H}_{y}}{\partial x} - \frac{\partial {H}_{x}}{\partial y} ) \hat{k} = ɛ \frac{\partial }{\partial t} {E}_{o} {e}^{j ( ω t - β z )} \cdot {e}^{- τ x} \hat{k}$$

From the study of Mentzer and Peters (1976) of a corrugated horn antenna: Hₓ=0

$$∴ \frac{\partial {H}_{y}}{\partial x} = ɛ \frac{\partial }{\partial t} {E}_{o} {e}^{j ( ω t - β z )} \cdot {e}^{- τ x}$$

$$\frac{\partial {H}_{y}}{\partial x} = j ω ɛ {E}_{o} {e}^{j ( ω t - β z )} \cdot {e}^{- τ x}$$

This leads to:

$${H}_{y} = j ω ɛ {E}_{o} {e}^{j ( ω t - β z )} \cdot \int {e}^{- τ x} \cdot dx \\ {H}_{y} = - j \frac{ωɛ}{τ} {E}_{o} {e}^{j ( ω t - β z )} \cdot {e}^{- τ x} \qquad ( A11 )$$

From Poynting's theorem:

$${p}_{z} ( x ) = \frac{1}{2} {E}_{x} \cdot {H}_{y}^{*} \\ {p}_{z} ( x ) = \frac{1}{2} \frac{ω ɛ β}{{τ}^{2}} {E}_{o}^{2} {e}^{j 2 ( ω t - β z )} \cdot {e}^{- 2 τ x} \qquad ( A12 )$$

The total power in the field is:

$${P}_{T} = \frac{1}{2} \frac{ω ɛ β}{{τ}^{2}} {E}_{o}^{2} {e}^{j 2 ( ω t - β z )} \cdot {\int }_{0}^{∞} {e}^{- 2 τ x} \cdot dx \cdot {\int }_{0}^{L} \cdot dy \\ {P}_{T} = \frac{L}{4} \frac{ω {ɛ}_{o} {κ}^{′} β}{{τ}^{3}} {E}_{o}^{2} \qquad ( A13 )$$

Therefore

$${E}_{o} = \sqrt{\frac{4 {τ}^{3} {P}_{T}}{L ω {ɛ}_{o} {κ}^{′} β}} \qquad ( A14 )$$

Note: the field in a wave guide is:

$${E}_{g} = \sqrt{\frac{4 η {P}_{T}}{ab}}$$

Where a and b are the dimensions of the wave guide (m).

$$η = \frac{{η}_{o}}{\sqrt{1 - {( \frac{{λ}_{o}}{2 a} )}^{2}}}$$

Therefore

$${E}_{g} = \sqrt{\frac{4 {η}_{o} {P}_{T}}{ab \sqrt{1 - {( \frac{{λ}_{o}}{2 a} )}^{2}}}}$$

The ratio of the field in the slow-wave structure and the field in a wave guide is:

$$\frac{{E}_{o}}{{E}_{g}} = \sqrt{\frac{{τ}^{3} ab \sqrt{1 - {( \frac{{λ}_{o}}{2 a} )}^{2}}}{{η}_{o} L {ωɛ}_{o} κ′β}}$$

In a lossy material, there is also longitudinal field absorption (Brodie 2008) in the dielectric media:

$$∴ {E}_{z} = {E}_{o} {e}^{j ( ω t - β z )} \cdot {e}^{- τx} \cdot {e}^{- α z} \hat{k} \qquad ( A15 )$$

Where

$$α = \frac{ω}{c} \sqrt{\frac{κ′}{2} ( \sqrt{1 + {( \frac{{κ}^{″}}{κ′} )}^{2}} 1 - )}$$

Now the temperature rise in a lossy material is:

$$\begin{matrix}\frac{d}{dt} T ( x , z ) = \frac{ω {ɛ}_{o} {κ}^{″} {E}_{o}^{2}}{ρ C} \cdot {e}^{- 2 τ x} & ( A16 ) \\ Or & \\ \frac{d}{dt} T ( x , z ) = \frac{4 {τ}^{3} {κ}^{″} {P}_{T}}{L βκ′ρ C} \cdot {e}^{- 2 τ x} & ( A 17 )\end{matrix}$$

Where ρ is the material density (kg m⁻³) and C is the thermal capacity of the material (J kg⁻¹ K⁻¹).

$$\begin{matrix}∴ T ( x , z ) = \frac{ω {ɛ}_{o} {κ}^{″} {E}_{o}^{2} \cdot {e}^{- 2 τ x}}{ρ C} {\int }_{0}^{ξ} dt & ( A18 ) \\ T ( x , z ) = \frac{ω {ɛ}_{o} {κ}^{″} {E}_{o}^{2}}{ρ C} ξ \cdot {e}^{- 2 τ x} + {T}_{i} & \\ T ( x , z ) = \frac{4 {τ}^{3} {κ}^{″} {P}_{T}}{L βκ′ρ C} ξ \cdot {e}^{- 2 τ x} + {T}_{i} & \end{matrix}$$

If the system is moving then equation (A12) can be modified to become:

$$\frac{d}{dt} T ( x , z ) \cdot \frac{dz}{dt} = \frac{ω {ɛ}_{o} {κ}^{″} {E}^{2}}{ρ C} \cdot {e}^{- 2 τ x}$$

Now

$$\frac{dz}{dt} = v ,$$

which is the longitudinal velocity of the system, therefore:

$$\begin{matrix}\frac{d}{dt} T ( x , z ) = \frac{ω {ɛ}_{o} {κ}^{″} {E}^{2}}{ρ C v} \cdot {e}^{- 2 τ x} \\ Or \\ T ( x , z ) = \frac{ω {ɛ}_{o} {κ}^{″} {E}^{2}}{ρ C v} \cdot {e}^{- 2 τ x} \cdot {\int }_{0}^{{L}_{a}} dz\end{matrix}$$

Where Lₐ is the length of the applicator. Therefore:

$$T ( x , z ) = \frac{ω {ɛ}_{o} {κ}^{″} {E}^{2}}{2 αρ C v} \cdot {L}_{a} \cdot {e}^{- 2 τx} \qquad ( A19 )$$

This can also be written as:

$$T ( x , z ) = \frac{2 {τ}^{3} {κ}^{″} {P}_{T}}{α v L βκ′ρ C} \cdot {L}_{a} \cdot {e}^{- 2 τx} \qquad ( A20 )$$

### EXAMPLES

Two slow wave applicators operating at 2.45 GHz according to the embodiment described above by reference to FIGS. 1 to 3 were designed and fabricated for testing. One has a comb structure with a groove depth of d=6 mm and the other has a groove depth of d=13 mm. The d=6 mm version has a smaller dispersion constant than the 13 mm version, allowing the resultant microwave field of the former to extend further from the surface of the structure. It is envisaged that this may be useful for heating the top layer of, for example, soil, as well as any plants growing above the surface of the soil. The d=13 mm version should confine the microwave fields very closely to the surface of the structure, so may be better suited for, for example, quickly treat growing plants with very little field penetration into the soil. In another embodiment (not shown), a grove depth of d=26 mm is utilised.

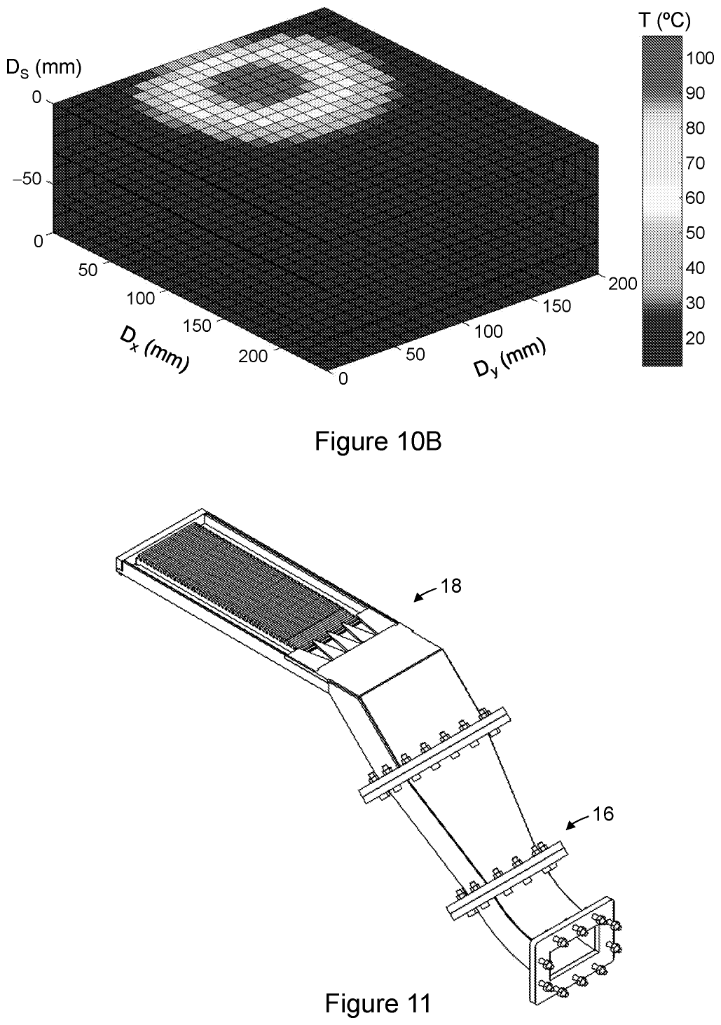

FIGS. 10A and 10B compare the calculated distributions of temperature increase of a horn antenna of the background art (FIG. 10A) and a slow-wave applicator according to this embodiment (FIG. 10B) when fed with 55.5 kJ of microwave energy, expected to be sufficient for the slow-wave applicator to treat a moderate volume of soil enough to kill weed seeds. In these figures, the vertical axis is soil depth Dₛ (mm). In FIG. 10A, the horizontal axes are the distances Dₓ (mm) and D_{y} (mm) from the centre line of the horn. In FIG. 10B, the horizontal axes are the distances Dₓ (mm) along and D_{y} (mm) across the applicator respectively.

The delivery of 55.5 kJ of microwave energy through a horn antenna, it will be noted, raises the soil temperature to between 30° C. and 33° C., which is expected to have no effect on seed viability. Indeed, calculations reveal that 240 kJ of microwave energy would be required from the horn antenna to achieve the same level of soil treatment obtained with the slow-wave applicator and sufficient to kill weed seeds. Hence, the slow-wave applicator provides an approximately fourfold improvement in microwave soil treatment efficacy, compared with a horn antenna arrangement.

The interesting feature of the slow-wave applicator is the total energy requirement to achieve good weed control. For example, it required a 20 s treatment using a 700 W microwave source to deliver the required energy density of 500 J cm⁻² needed to kill annual ryegrass plants, while the horn antenna system required 120 s from a 2 kW microwave source to deliver the same energy density at ground level.

Similar total energy savings were also apparent for other species (including wild radish, wild oats, annual ryegrass, perennial ryegrass, barnyard grass, fleabane, feathertop, barnyard grass and brome grass) tested in these experiments. In terms of total microwave energy requirements, the slow-wave applicator is more effective at treating weed plants, requiring only about 2-6% of the total energy needed from the horn antenna system.

The slow-wave applicator of these examples thus appears to provide a useful option for a viable microwave weed killer for agricultural and environmental systems, with improved efficacy of microwave soil and plant treatment by a factor of about 4 and 17, respectively.

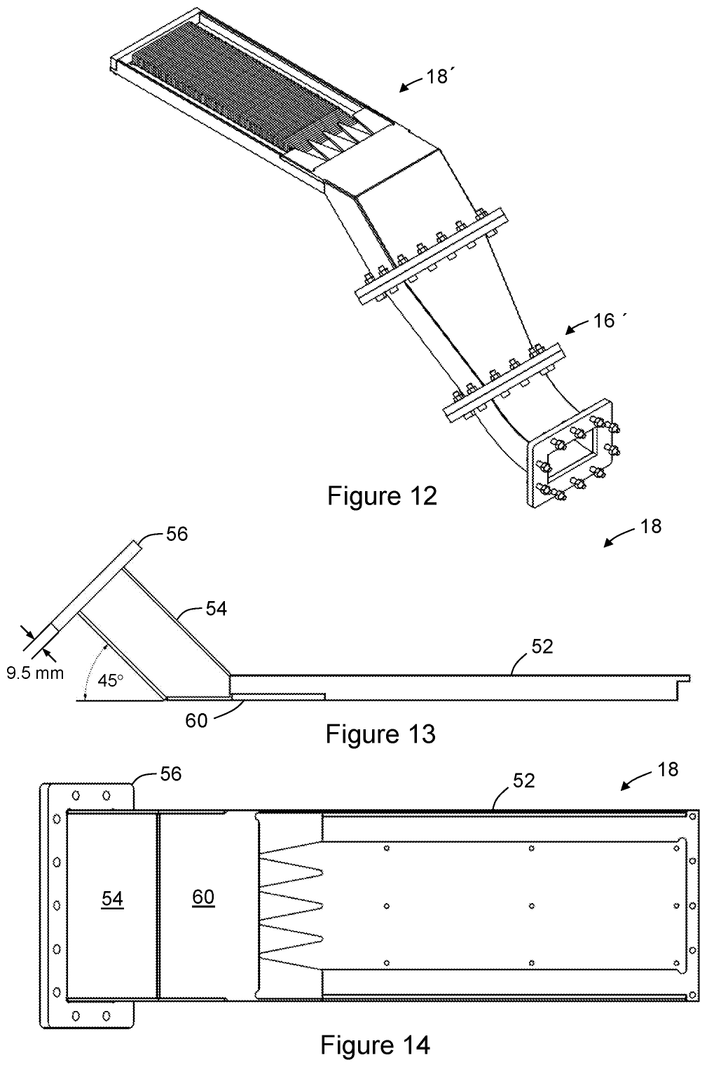

FIGS. 11 to 12 are schematic views, comparable to that of FIG. 3, of a microwave waveguide and slow-wave microwave applicator according to two embodiments of the present invention, constructed principally of aluminum for its lightness but with steel nuts and bolts fastening the various portions of these elements together. Other metals may be employed instead of aluminum (such as stainless steel or brass), provided they can act as required as a microwave waveguide. If a heavier material is employed, microwave energy application apparatus 10 may be deployed or provided with additional support at the distal end of slow-wave microwave applicator 18, such as a cradle or a jockey wheel.

FIG. 11 is a schematic view of microwave waveguide 16 and slow-wave microwave applicator 18 of the embodiment of FIGS. 1 to 3, with a groove depth of d=6 mm, while FIG. 12 is a schematic view of a slow-wave microwave applicator 18′ with microwave waveguide 16 of a similar embodiment but with a groove depth of d=13 mm.

As shown schematically in elevation in FIG. 13 (with slow-wave structure 20 omitted), each of slow-wave microwave applicators 18,18′ comprises an applicator housing 52 and an angled transitional microwave conduit 54, which is provided with a flange 56 for attaching the slow-wave microwave applicator 18,18′ to microwave waveguide 16.

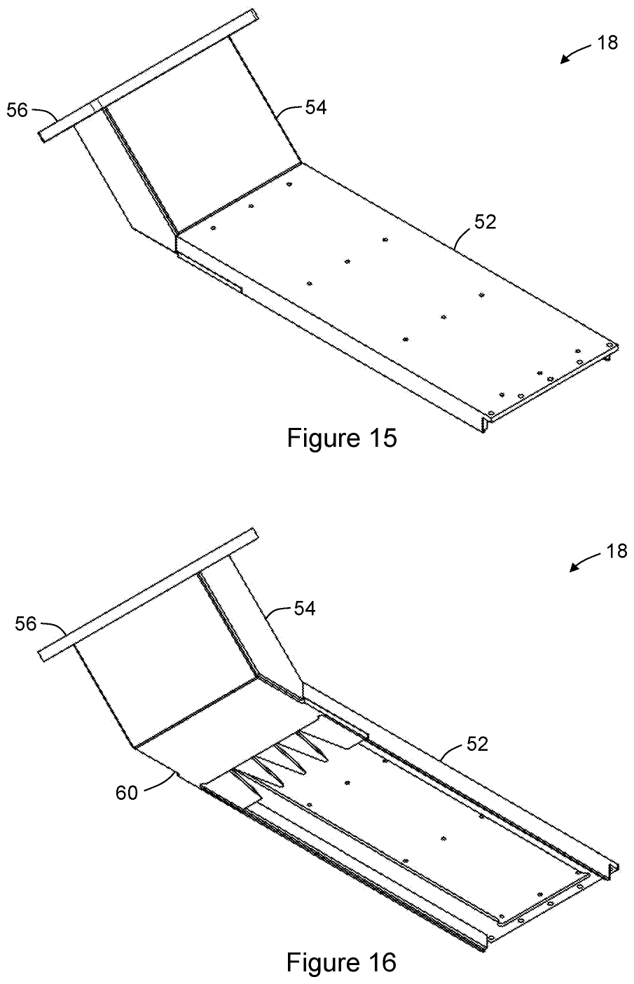

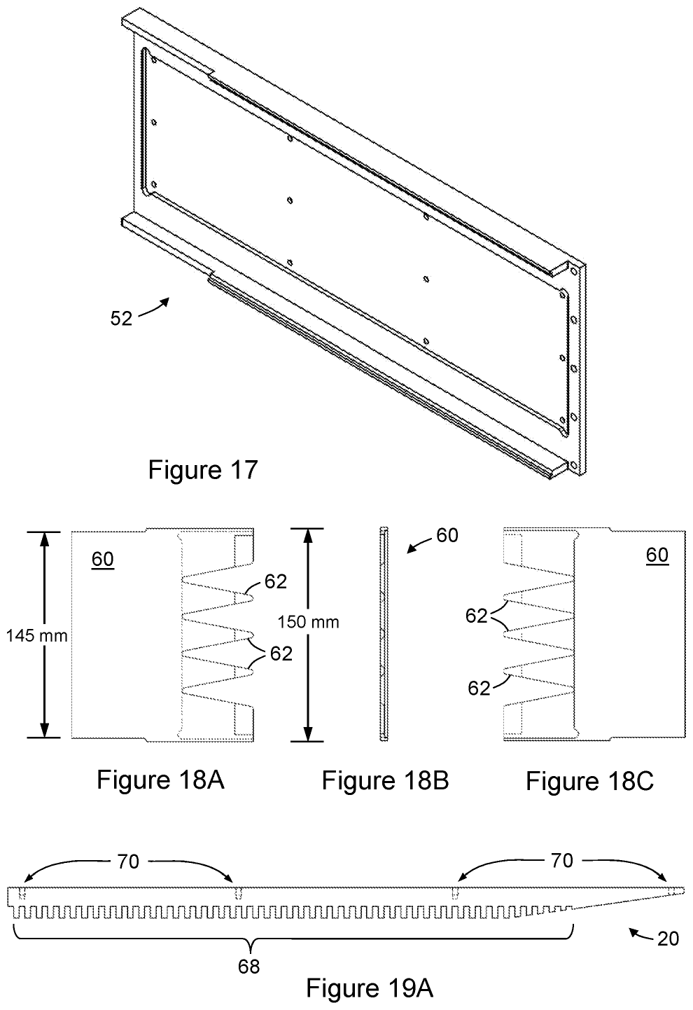

FIGS. 14 to 16 are further views of slow-wave microwave applicators 18,18′, being a bottom view, a top orthographic view and a bottom orthographic view respectively (with slow-wave structure 20 again omitted). FIG. 17 is a schematic bottom orthographic view of applicator housing 52.

FIGS. 18A to 18C are top, cross-sectional and bottom views, respectively, of a transitional portion 60 of slow-wave microwave applicators 18,18′; this portion 60 is a key part of the transition between angled transitional microwave conduit 54 and applicator housing 52/slow-wave structure 20. Transitional portion 60 translates the microwave's electric field from an essentially vertical orientation in the distal portion of transitional microwave conduit 54 into an essentially horizontal orientation in slow-wave structure 20. This phasor translation is done in conjunction with the initial tapered section of slow-wave structure 20. The three prongs 62 apparent in FIGS. 18A and 18C are adapted to make this translation less abrupt, reducing the impedance mismatch that occurs during this field orientation change, and which would otherwise create reflections that would reduce the transfer of energy from transitional microwave conduit 54 to slow-wave structure 20.

FIG. 19A is a schematic elevation of slow-wave structure 20 of slow-wave microwave applicator 18 (i.e. with groove depth d=6 mm) including grooves 68 and bores 70 for fastening slow-wave structure 20 to applicator housing 52, while FIG. 19B is a schematic elevation of the applicator 20′ of slow-wave microwave applicator 18′ (i.e. with groove depth d=13 mm) including grooves 68′ and bores 70′ for fastening slow-wave structure 20′ to applicator housing 52. In these views, the right end of slow-wave structure 20 is, in the assembled slow-wave microwave applicator 18,18′, located at the proximal end of applicator housing 52. The overall length of slow-wave structure 20 of this embodiment is approximately 356 mm, its width 100 mm, and its height 16 mm. The length may be varied to an extent; it could, for example, be shortened with a minor loss of efficiency (as most of the microwave energy is absorbed before the distal end of the slow-wave structure). The width of slow-wave structure 20, however, is selected to be approximately half the wavelength of the microwave radiation, so is a more critical dimension. However, some departure in width from half the wavelength is expected still to yield viable embodiments. For example, a small increase in the width should still work, but the microwave mode may change so that, instead of only one peak of energy across the applicator, there may be two.

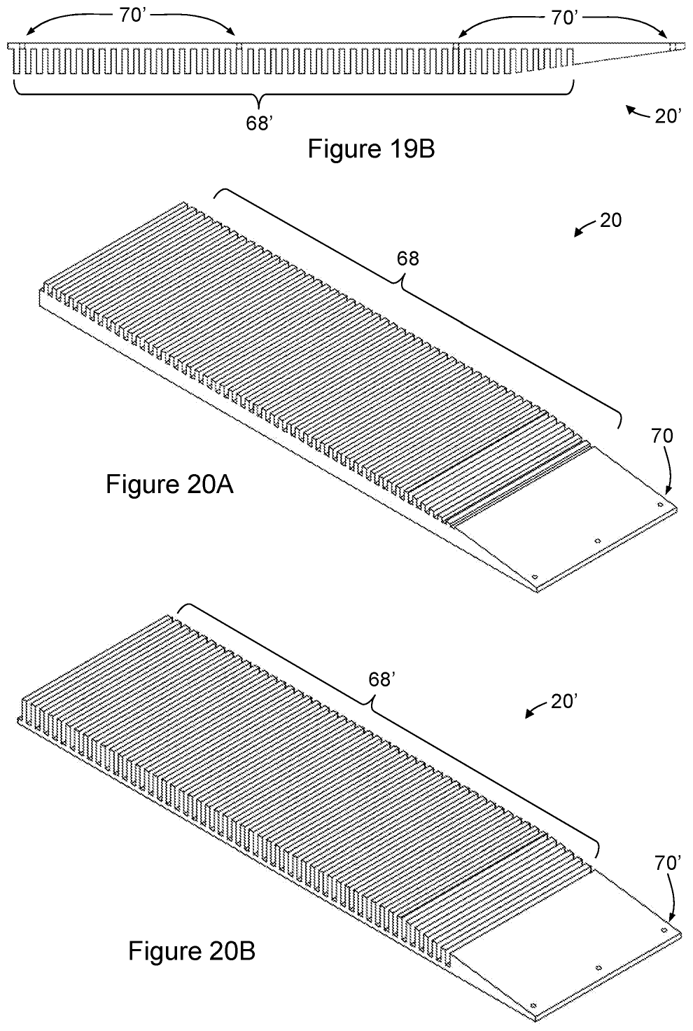

FIG. 20A is a bottom orthographic view of slow-wave structure 20 of slow-wave microwave applicator 18, while FIG. 20B is a bottom orthographic view of the slow-wave structure 20′ of slow-wave microwave applicator 18′.

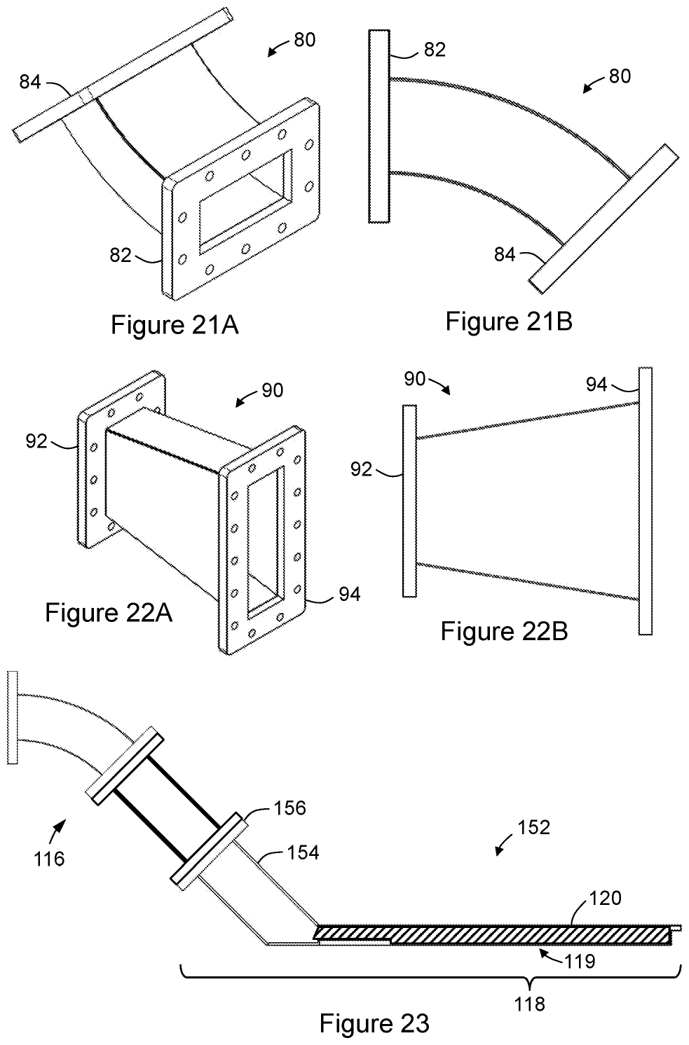

Microwave waveguide 16 comprises a bend section couplable to the microwave energy source 14, and a transition section coupled to the bend section and couplable to slow-wave microwave applicator 18,18′. FIG. 21A is a bottom orthographic view of bend section 80, while FIG. 21B is a schematic elevation of bend section 80. Bend section 80 includes a first flange 82 for coupling bend section 80 to microwave energy source 14, and a second flange 84 for coupling bend section 80 to transition section 90.

FIG. 22A is an orthographic view of transition section 90, and FIG. 22B is a schematic plan view of transition section 90. Transition section 90 includes a first flange 92 for coupling transition section 90 to bend section 80, and a second flange 94 for coupling transition section 90 to microwave applicator 18,18′.

In use, microwave energy application apparatus 10 is positioned close to the material to be irradiated (e.g. soil), but an advantage of microwave energy application apparatus 10 over a horn antenna device is that it has a penetration depth of 2 to 3 cm and does not radiate with significant intensity over greater distances. Hence, an operator may safely approach (perhaps inadvertently) slow-wave structure 20 while in use to within, in a typical application of the type described above, 10 cm—whereas it would generally be unsafe to approach a comparable horn antenna device while in use, with a penetration depth of about 10 cm, within about 2 m.

Microwave energy application apparatus 10 should also be usable in most typically weather conditions, though its penetration depth will be reduced in wet soil. This effect may be compensated for, in some cases, by increasing energy output.

It is envisaged that, in typical applications, a suitable combination of output power and speed of passing over the material to be treated (e.g. soil, cargo, etc.) would be established so that the desired effect would be achieved in one pass. Optionally, the temperature of the treated material may be monitored by monitoring the temperature to which the material is raised. The temperature may then be used as a basis for varying the output power and/or speed until the desired temperature is achieved. This may be done by coupling the output of a digital thermometer (e.g. in contact with the material or sensitive to infrared radiation emitted by the material) to microwave energy source 14 and/or a drive controlling the speed with which microwave energy application apparatus 10 and the material move relative to each other, so that feedback quickly leads to the desired temperature being produced in the treated material.

In a variation (not shown), slow-wave microwave applicator 18,18′ is covered by ceramic, glass or other materials for mechanical protection of the slow-wave microwave applicator 18,18′ during use from soil damage. Additionally, such a cover may provide for better impedance matching of the slow-wave microwave applicator 18,18′ with the soil.

According to another embodiment of the present invention, there is provided a microwave energy application apparatus, shown schematically at 100 in FIG. 23 (though with its electrical generator and microwave energy source or sources omitted for simplicity). Microwave energy application apparatus 100 is in most respects identical to microwave energy application apparatus 10 of FIG. 1, and is also intended principally for killing weeds, etc. It may also be employed, however, in the diverse manner in which microwave energy application apparatus 10 and its variants are deployed.

Microwave energy application apparatus 100 includes, therefore, a microwave waveguide 116 and a microwave applicator 118. Microwave applicator 118 includes an applicator housing 152 and an angled transitional microwave conduit 154, which is provided with a flange 156 for attaching microwave applicator 118 to microwave waveguide 116. However, in this embodiment, microwave applicator 118 includes a dielectric resonator comprising an alumina based ceramic block 120 (with a dielectric constant of 9 and a loss tangent of 0.0006). Other materials, such as glass (e.g. fused silica glass), Teflon (trade mark) or mica, may alternatively be employed instead of this or other ceramics, provided that they can act as a suitable dielectric resonator. Indeed, it is envisaged that dielectric materials with a loss tangent equal to or less than that of alumina (including polyethlylene, polypropylene, CPE, polystyrene, boron nitride, sapphire, magnesium oxide, beryllium oxide, and cross-linked polystyrene) would be suitable.

Also, the material should preferably have sufficient physical resilience, such as to cope with being bumped around in the field (if intended for such an application).

As shown, similar to the embodiment comprising a slow-wave microwave applicator 18, the present embodiment emits microwave energy from a substantially planar face. As can be seen, the waveguide 116 directs microwave energy into the dielectric resonator at an angle substantially perpendicular to the direction at which microwave energy is emitted from the dielectric resonator.

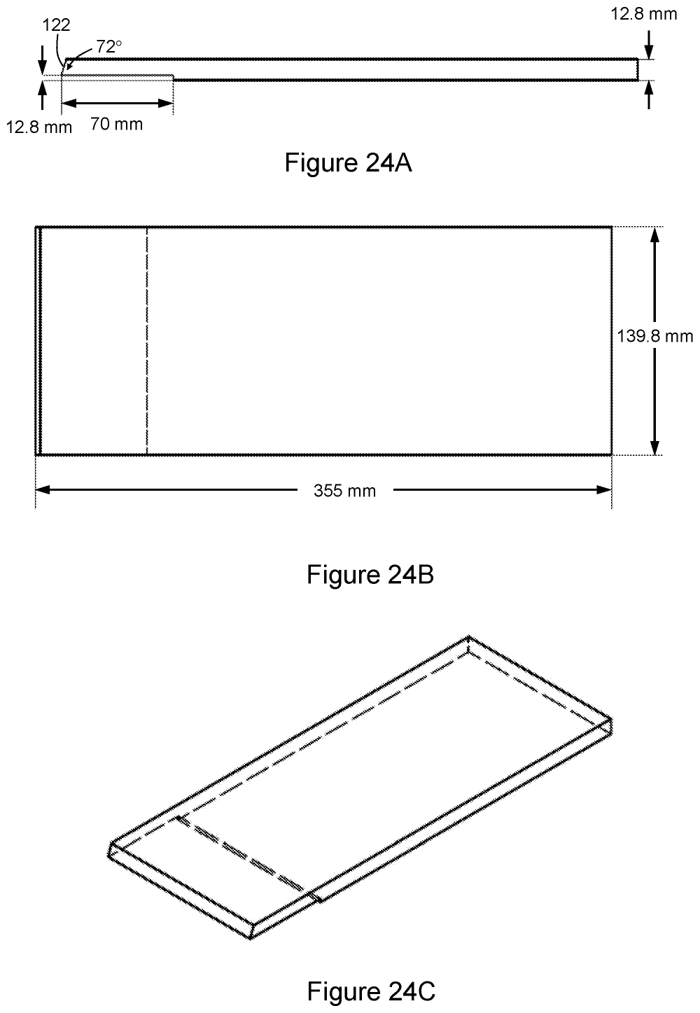

FIGS. 24A to 24C are elevation, plan and isometric views respectfully of the ceramic block 120 of the microwave energy application apparatus 100 of FIG. 23. Ceramic block 120 is sized so that it may be accommodated by applicator housing 52 of apparatus 10 of FIG. 1, but this is for convenience: other dimensions are possible.

Microwave applicator 118, by virtue of ceramic block 120, also provides a microwave field that decays exponentially in a direction away from its downwardly directed microwave energy emitting face 119. It does so by acting as a dielectric resonator in which evanescent microwave fields are created by internally reflected microwave fields and thus may be described as a frustrated total internal reflection microwave applicator.

The evanescent fields extend for most of the applicator's length and width, and decay exponentially below the applicator surface, that is, microwave energy emitting face 119. This minimises the depth of microwave heating into the soil, therefore reducing the energy requirements to—in this embodiment—heat and thereby kill weeds. This maximises the treatment efficiency.

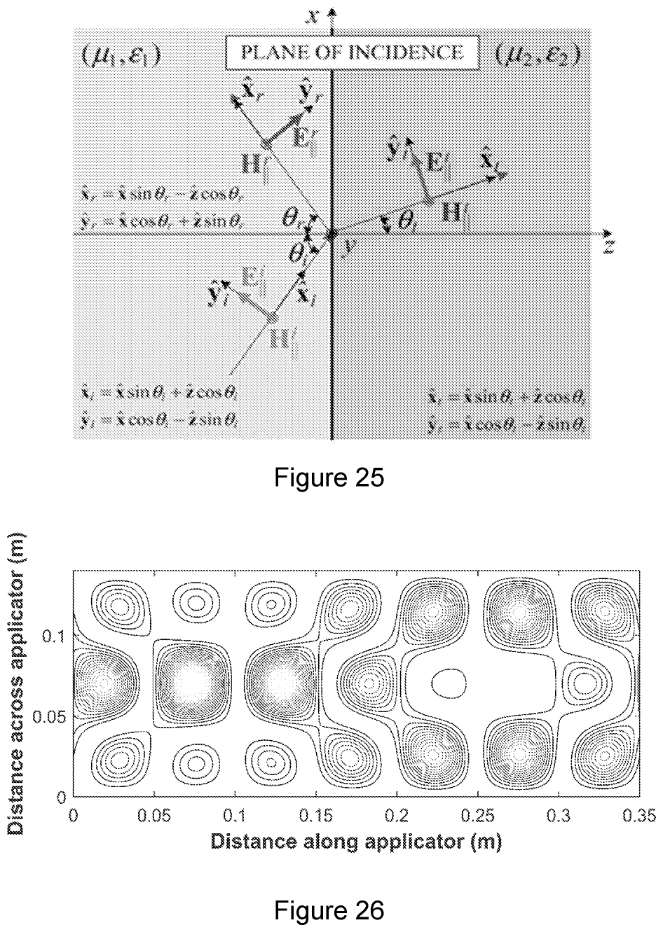

Without wishing to be bound by theory, the operation of embodiments based on a dielectric material—as best understood—is as follows. Referring to FIG. 25, when a wave is transmitted along an electrically dense dielectric material such that the field is incident onto an interface with a less electrically dense material. Part of the field will be reflected and part of the field will be transmitted.

In this case, the transmitted field can be described by:

Eₜ=Eₒe^{j(kr\hat{x}}^{ₜ}^{-ωt)} (B1)

In the second medium:

\hat{x}ₜ=\hat{x} sin θₜ+\hat{z} cos θₜ (B2)

Now:

cos θₜ=\sqrt{1−sin² θₜ} (B3)

and

$$sin {θ}_{t} = \frac{{n}_{1}}{{n}_{2}} sin {θ}_{i} \qquad ( B4 )$$

where n₁ and n₂ are the refractive indices of the two media.

In the case where n₁>>n₂, it is possible for there to be no transmitted wave

$$( i . e . {θ}_{t} \geq \frac{π}{2} ) .$$

The critical angle of incident (θ_{c}) occurs when:

$${θ}_{c} = {sin}^{- 1} ( \frac{{n}_{2}}{{n}_{1}} sin \frac{π}{2} ) = {sin}^{- 1} ( \frac{{n}_{2}}{{n}_{1}} ) \qquad ( B5 )$$

In the case of an interface between air and an alumina dielectric block, the dielectric constant n₂ is about 9.8. The dielectric constant of air n₁ is 1.0; therefore,

$${θ}_{c} = {sin}^{- 1} ( \frac{1.0}{\sqrt{9.8}} ) = 18.6 ° .$$

Hence, if the microwave fields travel along the medium (such as a ceramic block) with an incident angle of greater than 18.6° there should be total internal reflection of the fields and the ceramic block will act as a dielectric resonator for the fields.

It is even possible for sin θₜ>1.0, in which case equation (B3) becomes:

cos θₜ=j\sqrt{sin² θₜ−1} (B6)

Substituting into equation (B1) yields:

$${E}_{t} = {E}_{o} {e}^{j ( κ′ [ \hat{x} sin {θ}_{t} + j \hat{z} \sqrt{{sin}^{2} {θ}_{t} - 1} ] - ω t )} . \qquad ( B7 )$$

This can be rearranged to yield:

$${E}_{t} = {E}_{o} {e}^{- \hat{z} {k}^{′} \sqrt{{sin}^{2} {θ}_{t} - 1}} \cdot {e}^{j ( \hat{x} {k}^{′} sin {θ}_{t} - ω t )} \qquad ( B 8 )$$

This equation describes an exponentially decaying field in the z direction which propagates along the interface surface in the x direction, according to the wave equation: e^{j(\hat{x}k′ sin θ}^{ₜ}^{-ωt)}.

In this case:

$${K}^{′} = \frac{ω {n}_{2}}{c} \qquad ( B 9 )$$

where, ω is the angular frequency of the wave (s⁻¹) and c is the speed of light (m s⁻¹).

Using equations (B4) and (B9), equation (B8) can be rewritten to become:

$${E}_{t} = {E}_{o} {e}^{- \hat{z} k \sqrt{{n}_{1}^{2} {sin}^{2} {θ}_{i} - {n}_{2}^{2}}} \cdot {e}^{j ( \hat{x} {kn}_{1} sin {θ}_{i} - ω t )} \qquad ( B10 )$$

where,

$$k = \frac{ω}{c} .$$

In a non-magnetic material, the refractive index of the material is nᵢ=\sqrt{κᵢ}, where

$${κ}_{i} = \frac{{ɛ}_{i}}{{ɛ}_{o}} .$$

In the case of a dielectric resonator, there will be a standing wave generated inside the ceramic block. Therefore, the field can be described by:

$${E}_{t} = {E}_{o} {e}^{- \hat{z} k \sqrt{{n}_{1}^{2} {sin}^{2} {θ}_{i} - {n}_{2}^{2}}} \cdot sin ( \frac{l π y}{a} ) \cdot sin ( \frac{m π z}{b} ) \cdot sin ( \frac{n π x}{c} ) \cdot {e}^{- j ω t} \qquad ( B 11 )$$

where l, m, and n are integers and a, b, and c are the dimensions of the dielectric block (m) in the lateral, vertical, and longitudinal dimensions of the ceramic resonator.

The alumina based ceramic block of the above-described embodiment has κ=9.8, a=140 mm, b=13 mm, and c=355 mm) and is electrically large enough to support multiple field modes during its resonance. For example, FIG. 26 is a contour diagram for the electric field distribution in ceramic block 120, when the microwave energy is being fed into the block from left to right (in the view of FIG. 23), for the combination of the TE₃₀₈ (l=3, m=0, and n=8) mode and the TE₁₀₆ (l=1, m=0, and n=6) mode. This compares favourably with the observed temperature distribution when the applicator was used to heat plywood, though it should be noted that, in the plywood experiment, the microwave field was fed into ceramic block 12 from right to left and it is likely to be supporting more than 2 modes simultaneously.

The reflection coefficient of the interface in FIG. 25 is:

$$Γ = \frac{{η}_{2} Cos ( {θ}_{t} ) - {η}_{1} cos ( {θ}_{i} )}{{η}_{2} Cos ( {θ}_{t} ) + {η}_{1} cos ( {θ}_{i} )} \qquad ( B 12 )$$

It follows that:

$$τ = \frac{2 {η}_{2} Cos ( {θ}_{i} )}{{η}_{2} Cos ( {θ}_{t} ) + {η}_{1} Cos ( {θ}_{i} )} \qquad ( B 13 )$$

When considering non-magnetic non-conductors,

$$\frac{{η}_{1}}{{η}_{2}} = \frac{{n}_{2}}{{n}_{1}}$$

so:

$$Γ = \frac{\frac{{n}_{1}}{{n}_{2}} Cos ( {θ}_{t} ) - Cos ( {θ}_{i} )}{\frac{{n}_{1}}{{n}_{2}} Cos ( {θ}_{t} ) + Cos ( {θ}_{i} )} \qquad ( B 14 )$$

Depending on the relative values of n₁ and n₂, the sign of the reflected wave can be positive or negative. The change of sign corresponds to a phase change of π between the incident and reflected waves. The transmitted wave is always in phase with the incident wave.

Since from Snell's law

$$\frac{{n}_{1}}{{n}_{2}} = \frac{Sin ( {θ}_{i} )}{Sin ( {θ}_{t} )} ,$$

equation (B14) can be rewritten as:

$$Γ = \frac{\frac{Sin ( {θ}_{i} )}{Sin ( {θ}_{t} )} Cos ( {θ}_{t} ) - Cos ( {θ}_{i} )}{\frac{Sin ( {θ}_{i} )}{Sin ( {θ}_{t} )} Cos ( {θ}_{t} ) + Cos ( {θ}_{i} )} = \frac{Sin ( {θ}_{i} ) Cos ( {θ}_{t} ) - Sin ( {θ}_{t} ) Cos ( {θ}_{i} )}{Sin ( {θ}_{i} ) Cos ( {θ}_{t} ) - Sin ( {θ}_{t} ) Cos ( {θ}_{i} )} = \frac{Tan ( {θ}_{i} - {θ}_{t} )}{Tan ( {θ}_{i} + {θ}_{t} )} \qquad ( B 15 )$$

While it is only possible for the numerator of equation (B13) to be zero when n₁=n₂, the equation can also equate to zero when tan(θᵢ+θₜ)=∞, which occurs when

$${θ}_{i} + {θ}_{t} = \frac{π}{2} .$$

This condition results in total transmission of the incident polarized wave across the material interface and the incident angle is referred to as Brewster's angle (θ_{B}). Brewster's angle can be determined using:

$${θ}_{B} = {tan}^{- 1} ( \frac{{n}_{2}}{{n}_{1}} ) \qquad ( B 16 )$$

In the case of an interface between air and an alumina dielectric block, the dielectric constant n₂ is about 9.8. The dielectric constant of air n₁ is 1.0; therefore,

$${θ}_{B} = {tan}^{- 1} ( \frac{\sqrt{9.8}}{1.0} ) = 72.3 ° .$$

Hence, the bevel of 72° in the incident face 122 of ceramic block 120 should provide optimal energy transfer into the applicator.

### EXAMPLES

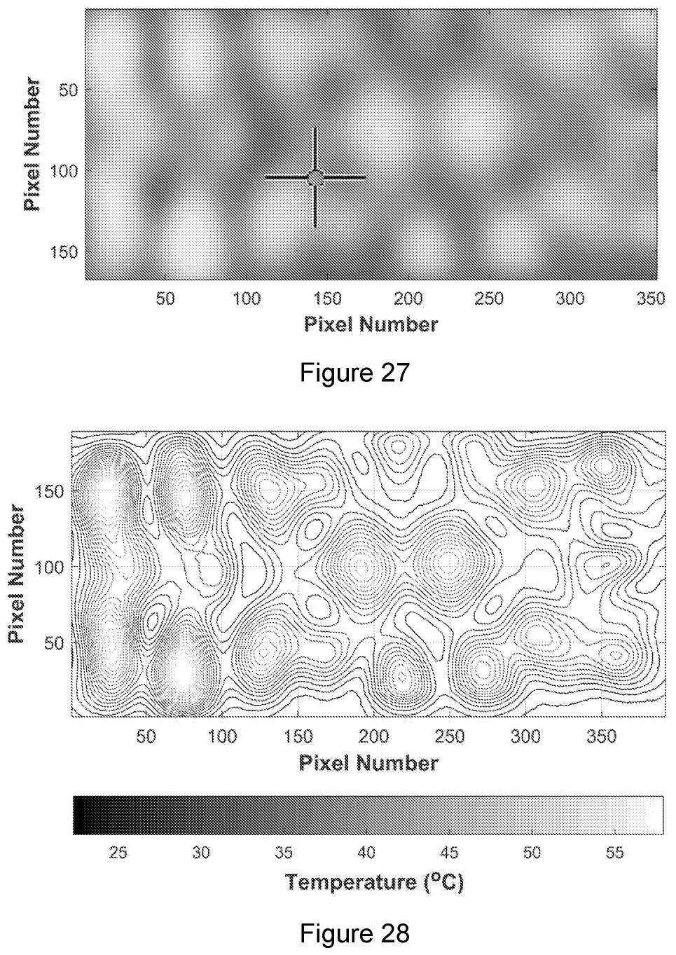

Thermal images were acquired to test the microwave heating effect of a microwave applicator constructed according to microwave applicator 118 of the embodiment of FIG. 23. Initially microwave applicator 118 was arranged to be 30 mm above a piece of plywood to determine its normal microwave field distribution: FIG. 27 is a thermal image of the plywood when heated using microwave applicator 118. The heating pattern is more clearly revealed by contour analysis of the thermal image: FIG. 28 is a thermal contour map of the thermal image of FIG. 27. This experiment represents the most likely behaviour of the applicator, because the plywood was dry and had a smooth surface.

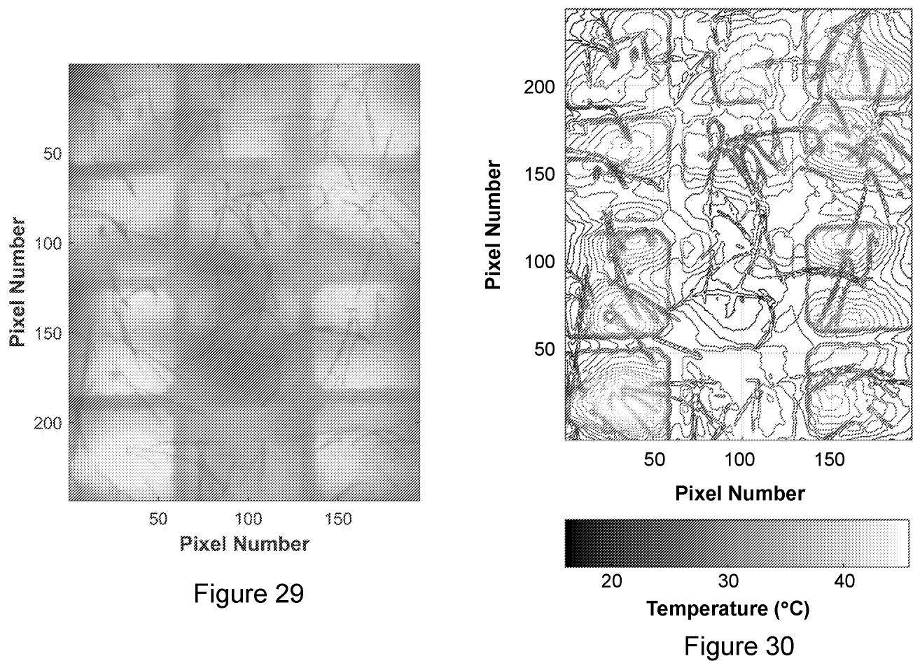

When microwave applicator 118 was hovered over the ground, the hearting pattern was found to be somewhat similar to that illustrated in FIG. 27. In the experiment undertaken to explore this scenario, planter trays of ryegrass were used as a test and the applicator was arranged about 30 mm above the surface of the soil in the trays. FIG. 29 is a thermal image of the resulting heating pattern of the soil when heated using microwave applicator 118; the heating pattern is relatively uniform as illustrated in both the thermal image (FIG. 29) and the corresponding thermal contour analysis (see FIG. 30).

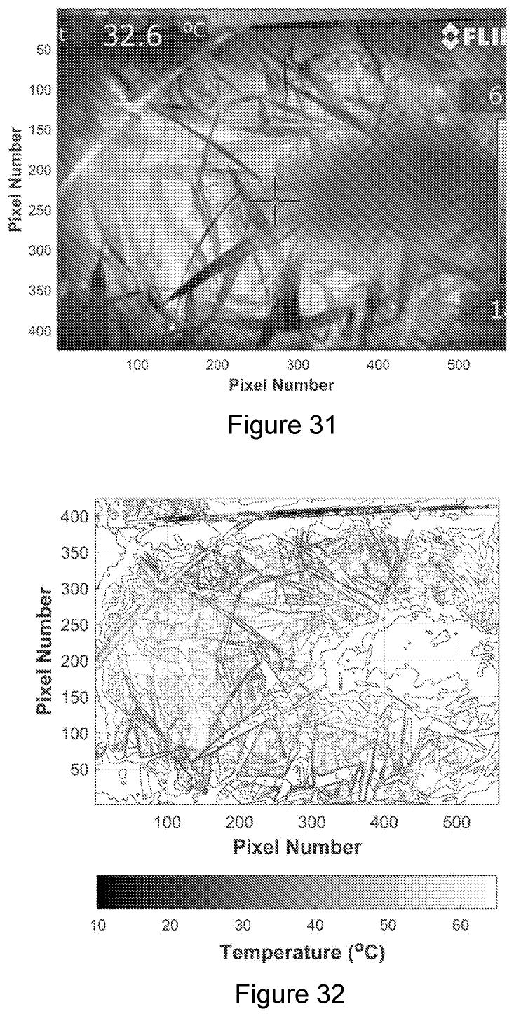

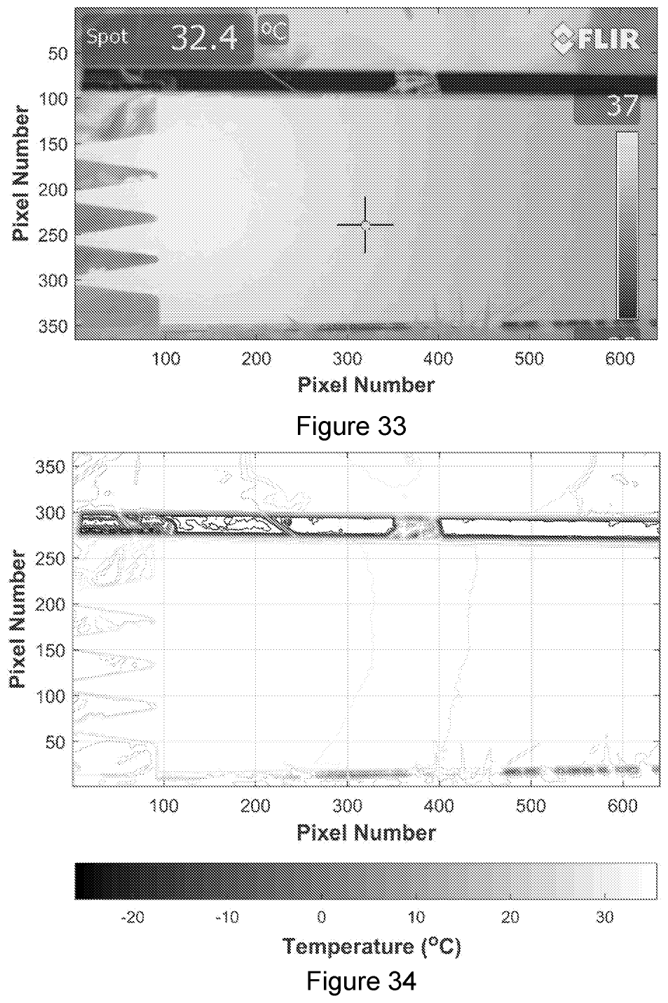

When microwave applicator 118 is placed onto the surface of the ground (such as to treat weeds), the evanescent fields are absorbed so the heating pattern is modified. The results of such a test are shown in the thermal image of the resulting heating pattern of FIG. 31 and the corresponding thermal contour analysis (see FIG. 32).

In all cases the soil temperature reached 50-65° C., which is sufficient to kill plants and some seeds in the surface layer of the soil. The combination of microwave energy and absorbed energy from the heated soil and weeds also slightly heats ceramic block 120: see the thermal image of the resulting heating pattern of ceramic block 120 (FIG. 33) after about 40 minutes of operation, and the corresponding thermal contour analysis (FIG. 34). This will also contribute a small amount of Infra-red heating to the soil, which should assist in weed killing, etc.

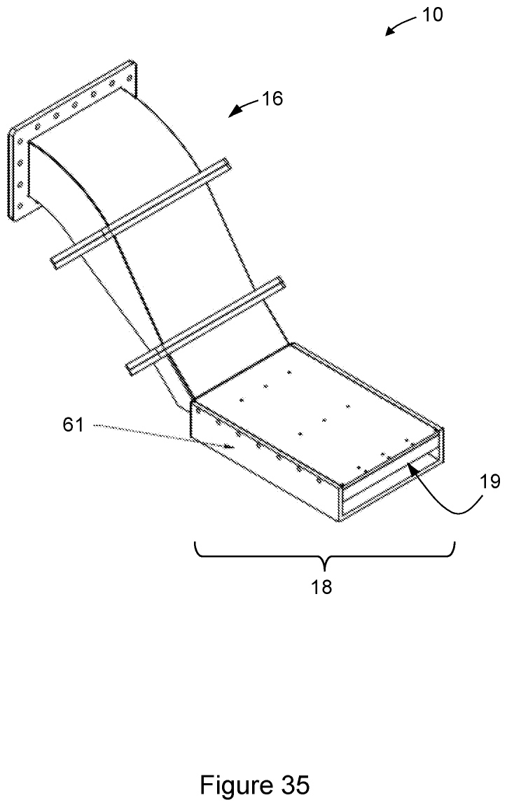

In an embodiment, as shown in FIG. 35, the microwave energy application apparatus 10 includes a reflector 61 positioned such as to reflect microwave radiation emitted from the microwave applicator 18 or 118 (e.g. a slow-wave microwave applicator 18 or a dielectric resonator 118)—the figure shows microwave energy application apparatus 10 with slow-wave microwave applicator 18. The reflector 61 is located opposite the emitting opening of the microwave applicator 18 and is configured such as to move through the terrain being irradiated (for example, through soil). The spacing between reflector 61 and microwave applicator 18 is sufficient to allow irradiation of a required depth (for example, of the soil).

In an example of the embodiment, at frequency 922 MHz, microwave energy penetrates deep to the soil (up to 120 mm) with the top 30 mm of the soil absorbing approximately 43-52% of the applied energy. Reflector 61 acts to reflect non-absorbed energy, with the soil absorbing a portion of this reflected energy. Therefore, the reflector 61 may advantageously improve the efficiency of microwave energy absorption by the soil.

In the embodiments described above, microwave energy application apparatus 10 is typically described as portable, mounted—for example—on a moving platform such as vehicle. In other applications, different moving platforms may be suitable—such as a movable gantry or trolley. In still other applications, the material to be treated may be moved past microwave energy application apparatus 10, such as on a conveyor belt.

It will be understood to those persons skilled in the art of the invention that many modifications may be made without departing from the scope of the invention. For example, in a variation to the embodiments herein described, the microwave applicator is surrounded by curtains from metal strips, chains or wire brushes (or other materials) tissue with metal fibre inclusions, in order to reduce microwave leakage.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will also be understood that the reference to any prior art in this specification is not, and should not be taken as an acknowledgement or any form of suggestion that, the prior art forms part of the common general knowledge in any country.

1-20. (canceled)

21. A microwave energy application apparatus for irradiating a material, comprising:
at least one microwave energy source configured to generate microwave energy;
at least one microwave applicator having a microwave energy emitting face comprising a dielectric resonator for directing microwave energy towards the material to be irradiated; and
a waveguide coupling microwave energy from the microwave energy source to the microwave applicator for application to a material to be treated.

22. A microwave energy application apparatus as claimed in claim 21, wherein the dielectric resonator comprises a ceramic, glass or Teflon.

23. A microwave energy application apparatus for irradiating a material, comprising:
at least one microwave energy source configured to generate microwave energy;
at least one microwave applicator having a microwave energy emitting face comprising a slow-wave microwave applicator having grooves arranged in parallel across a direction of propagation of the microwave energy; and
a waveguide coupling microwave energy from the microwave energy source to the microwave applicator for application to a material to be treated.

24. A microwave energy application apparatus as claimed in claim 23, wherein the grooves have a depth of between 6 and 26 mm.

25. A microwave energy application apparatus as claimed in claim 24, wherein the grooves have a depth of between 6 and 13 mm.

26. A microwave energy application apparatus as claimed in claim 24, wherein the grooves have a depth of between 13 and 26 mm.

27. A microwave energy application apparatus as claimed in claim 23, wherein the grooves are perpendicular to the direction of propagation of the microwave energy.

28. A microwave energy application apparatus as claimed in claim 23, wherein the grooves are mutually spaced substantially equidistantly.

29. A microwave energy application apparatus for irradiating a material, comprising:
at least one microwave energy source configured to generate microwave energy;
at least one microwave applicator having a microwave energy emitting face for emitting microwave energy; and
a waveguide coupling microwave energy from the microwave energy source to the microwave applicator for application to a material to be treated,
wherein the microwave energy decays exponentially with distance from the microwave energy emitting face.

30. A microwave energy application apparatus as claimed in claim 29, wherein the microwave energy source is configured to output microwave energy with a frequency of approximately 2.45 GHz.

31. A microwave energy application apparatus as claimed in claim 29, wherein the microwave energy source is configured to output microwave energy with a frequency of approximately 860 MHz to 960 MHz.

32. A microwave energy application apparatus as claimed in claim 29, wherein the microwave energy source is configured to output microwave energy with a frequency of approximately 5.8 GHz.

33. A microwave energy application apparatus as claimed in claim 29, wherein the microwave energy emitting face is planar.

34. A microwave energy application apparatus as claimed in claim 29, further comprising a reflector located to reflect microwave energy emitted from the microwave energy emitting face, such that the material moves between the reflector and the microwave energy emitting face.

35. A weed, parasite, bacteria, fungi, spore or seed killing device, comprising one or more microwave energy application apparatuses as claimed in claim 29.

36. A soil sterilizing, conditioning or nitrification device, comprising one or more microwave energy application apparatuses as claimed in claim 29.

37. A drying device, comprising one or more microwave energy application apparatuses as claimed in claim 29.

38. A microwave energy application method, comprising:
providing microwave energy with at least one microwave energy source;
receiving the microwave energy from the microwave energy source with at least one microwave applicator; and
applying the microwave energy with the microwave applicator to a material to be treated;
wherein the microwave applicator comprises one of: a dielectric resonator; and a slow-wave microwave applicator having grooves arranged in parallel across a direction of propagation of the microwave energy.

39. A microwave energy application method, comprising:
providing microwave energy with at least one microwave energy source;
receiving the microwave energy from the microwave energy source with at least microwave applicator; and
applying the microwave energy with the microwave applicator to a material to be treated; wherein the microwave energy decays exponentially with distance from the microwave energy emitting face.

40. A microwave energy application apparatus as claimed in claim 29, wherein the microwave energy emitting face of at least one microwave applicator comprises a dielectric resonator for directing microwave energy towards the material to be irradiated or wherein the microwave energy emitting face of at least one microwave applicator comprises a slow-wave microwave applicator having grooves arranged in parallel across a direction of propagation of the microwave energy.
